(19) United States
(12) Patent Application Publication
(10) Pub. No.: US 2009/0255693 A1
(43) Pub. Date: Oct. 15, 2009

(54) SPRINKLER HEAD

(76) Inventors: Koki Sato, Iwate (JP); Yoshiki Sato, Iwate (JP)

Correspondence Address: WENDEROTH, LIND & PONACK, L.L.P., 1030 15th Street, N.W.,, Suite 400 East, Washington, DC, 20005-1503, US

(21) Appl. No.: 12/374,861

(22) PCT Filed: Jul. 23, 2007
(86) PCT No.: PCT/JP2007/000786

§ 371 Date: Apr. 27, 2009

(30) Foreign Application Priority Data
Jul. 24, 2006 (JP) 2006-200159

(51) Int. Cl. A62C 31/02

(52) U.S. Cl. 169/37

(57) ABSTRACT

An object of the present invention is to provide a sprinkler head having a heat-sensitive decomposition structure provided by a link comprising two sheets of metal plates connected together by means of a fusible alloy, characterized in that the applied load is uniformly distributed over the link and that the sprinkler head is highly impact-resistant.

In a sprinkler head of the present invention, each of a pair of levers 5 to be engaged with the link 6 is formed into an L-shape, and a space is formed in a bent portion 22 of the L-shape, wherein respective bent portions 22 are held in contact with each other. In addition, the bent portions 22 are provided with a specific contact region such as a mating construction so that respective levers can be held in position.

### TECHNICAL FIELD

The present invention relates to a sprinkler head for extinguishing a fire.

### BACKGROUND ART

A sprinkler head used for fire extinguishing typically has such a structure in which an internal nozzle is placed in communication with a water supply piping system and the sprinkler head is activated upon detection of heat from a fire to allow an amount of water to be discharged from the nozzle and directed to impinge upon a plate-like deflector disposed ahead of the nozzle so that the water can be scattered in all directions within a room in which a fire extinguishing operation is provided.

In the sprinkler head, a heat-sensitive decomposition structure is decomposed in an environment at an extremely high temperature caused by a fire so as to permit a valve body that has been held in closed position by the heat-sensitive decomposition structure to open so that the water can be dispersed for providing the fire extinguishing operation.

It has been commonly known that a fusible alloy is employed as a heat sensitive material used in the heat-sensitive decomposition structure of the sprinkler head. The sprinkler head having employed the fusible alloy as the heat-sensitive material in the heat-sensitive decomposition structure essentially has an excellent feature that there will be no variability in activation of the sprinkler head due to the specific melting point which is inherently determined by the composition, ratio or the like of blending of the fusible alloy. One among other heat-sensitive decomposition structures employing the fusible alloy is represented by a wrap-joint type structure.

The wrap-joint type of heat-sensitive decomposition structures comprises two sheets of metal plates connected together with a fusible alloy. The wrap joint type structure is characterized by having such a structure that each of the metal sheets at its edge is engaged with one end of levers, whose other end serves to hold the valve body of the sprinkler head in a closed position. In the sprinkler head incorporated with the wrap-joint type of heat-sensitive decomposition structure, in case of fire, the heat from the fire melts the fusible alloy and allows the metal plates to separate from each other, thus disengaging the levers for opening the valve body.

FIG. 7 illustrates, by way of example, a sprinkler head equipped with the wrap-joint type of heat-sensitive decomposition structure (see Patent document 1). As illustrated, the sprinkler head has a main body 110 including a nozzle 114 formed therein, and an outlet of the nozzle 114 is closed by a valve body 126 via a sealing member 130. The valve body 126 is pressed against the outlet of the nozzle 114 by an adjusting screw 134 from the opposite side of the nozzle 114, wherein the adjusting screw 134 is threadingly engaged with a female screw portion provided in a central location of an adjuster plate 136, which is in turn interposed between the valve body 126 and a pair of pins 138 which correspond to the above mentioned levers.

One end of the pins 138 are engaged with a step formed at a lower end 142 of the main body 110 and fixedly clamped by and between the adjuster plate 136 and the step at the lower end 142 of the main body. The other ends of the pins 138 are engaged with a link 40 comprising two sheets of metal plates connected together with a fusible alloy.

In case of fire, the fusible alloy connecting the metal plates melts so as to allow the two metal plates to separate from each other, and the pins 138 are disengaged from the main body 110 for opening the valve body 126. When the valve body 126 is opened, an amount of water held within the nozzle 114 is discharged for extinguishing the fire.

[Patent document 1] Specification and FIG. 1 from the U.S. Pat. No. 6,152,236

### DISCLOSURE OF THE INVENTION

### Problem to be Solved by the Invention

In the sprinkler head having the structure as described above, the adjusting screw is threaded into the female screw in the adjuster plate to thereby apply a load to the valve body and the pins, in order to press the valve body against the nozzle outlet and to firmly engage the pins with the step at the lower end of the main body. An aperture is provided in a central region of the link and additionally a sufficient space is provided between the pins, to allow a tool, such as a driver and the like, to pass therethrough to thread the adjusting screw into the adjuster plate.

If the pins are positioned asymmetrically when the adjusting screw is threaded into the adjuster plate, then the link could be positioned obliquely or there could be an imbalance in loading applied to the pins, which possibly leads to a load greater than a predetermined level applied to the link.

In addition, there will be a risk that when the sprinkler head undergoes an impact from a severe earthquake or the like, the pins could be displaced, which could possibly lead to a future untimely water discharging operation.

The present invention is directed to solve the problems as described above and an object thereof is to provide a sprinkler head in which the applied load is uniformly distributed over the link and additionally which is highly impact-resistant.

### Means for Solving the Problems

To accomplish the object as stated above, the invention as set forth in claim 1 provides a sprinkler head comprising a main body having a nozzle connected to a water supply piping, in which an outlet of the nozzle is closed by a valve body, the valve body is pressed against the outlet of the nozzle by a set-screw from the opposite side of the nozzle, and the set-screw is threadingly engaged with a female screw in a saddle interposed between the valve body and a pair of levers, whose one end are engaged with a step provided at a lower end of the main body, wherein the levers are fixedly clamped by and between the step and the saddle by threading the set-screw into the saddle, and the other ends of the levers are engaged with a heat-sensitive decomposition structure comprising two sheets of metal plates connected together with a fusible alloy, the sprinkler head being characterized in that the levers are provided with contact regions in their intermediate portions respectively, which are capable of being held in contact with each other while the levers are engaged with the heat-sensitive decomposition structure and in that a space is formed in the intermediate portions of the levers along an axis of the female screw in the saddle.

The invention as set forth in claim 2 provides a sprinkler head in accordance with the invention defined in claim 1, characterized in that the lever is formed into an L-shape by bending an intermediate portion thereof.

The invention as set forth in claim 3 provides a sprinkler head in accordance with the invention defined in claim 2, characterized in that the space formed in the bent portion of the lever is an aperture.

The invention as set forth in claim 4 provides a sprinkler head in accordance with the invention defined in claim 2, characterized in that the space formed in the bent portion of the lever is a notch.

The invention as set forth in claim 5 provides a sprinkler head in accordance with the invention defined in claim 1, characterized in that the contact region of the lever comprises a contact portion formed to extend from the intermediate portion of one lever toward the other lever.

### ADVANTAGES OF THE INVENTION

According to the invention as defined in claim 1, the pair of levers is assembled such that they are placed in contact with each other, and this can prevent any relative displacement or offset of the levers during manufacturing of the sprinkler head. In addition, the above structure of the levers can more positively prevent the relative displacement of the levers and resultant imbalance in loading applied to the levers when they undergo an impact, compared with the levers placed not-in contact with each other. Further, during manufacturing, a unit of structure in the course of construction can rest as in the condition with the link being engaged with the lower ends of the levers, and this allows the lot management and manufacturing by assembly units.

According to the invention as defined in claim 2, the contact region, which may be provided by a pair of mating configurations, for example, can facilitate the connection or positioning of one of the levers with respect to the other, and thus can improve efficiency in assembly work during the manufacturing process.

According to the invention as defined in claim 3, since the space in the bent portion of the lever is formed by an aperture, it facilitates the formation of the component, and a symmetric geometry of the components allows a pair of levers to be constructed by using identical components. In addition, according to the description in claim 4, since the notch is employed as the geometry of the space, it is possible to take advantage of the notch geometry in conjunction with the formation of the contact region as described in claim 2.

According to the invention as defined in claim 5, the formation of the lever geometry and the space is facilitated.

### PREFERRED EMBODIMENT OF THE INVENTION

In embodying the present invention, it is also possible that the contact region as described in claim 1 may be provided by forming planer surfaces at which the levers are brought into contact with each other, and detachably connecting those surfaces by using grease, and further, the contact region may be formed with mating configuration, such as combination of a convex and a concave feature.

Further, the space formed in the lever bent portion may be an opening or may be formed by the notch.

### Example

Preferred embodiments of the present invention will be now described with reference to FIGS. 1 to 6. FIG. 1 is a sectional view of a sprinkler head of the present invention, FIG. 2 is a sectional view of the sprinkler head taken along the X-X line of FIG. 1, FIGS. 3(a)-3(c) represent alternative embodiments of a lever, FIG. 4 is a sectional view of a sprinkler head incorporated with a lever according to the alternative embodiment, FIG. 5 is an exploded perspective view of a link and FIG. 6 shows the sprinkler head of FIG. 1 in operation.

The sprinkler head as shown in FIGS. 1 and 2 comprises a main body 1, a valve body 2, a deflector 3, a saddle 4, a pair of levers 5 and a link 6.

The main body 1 is cylindrical in shape and has a nozzle 7 formed inside thereof, wherein a male screw 8 is provided on an outer circumferential surface of the nozzle 7 for connection with a water supply piping system. A portion below the male screw 8 defines a collar 9 in an outwardly extending flange configuration and the collar 9 includes a plurality of holes 11 equally spaced apart for fixedly mounting a cylinder 10 to be connected with the main body 1.

The cylinder 10 is designed to be fixedly mounted to the main body 1, as stated above, and accordingly it has, at its upper end, protrusions 12 to be fittingly inserted into the holes 11 formed in the collar 9 of the main body. The protrusions 12 may be inserted through the holes 11 of the collar 9, and a load is applied to, and thus deforms, tips of the protrusions 12 so as to fix the cylinder 10 to the main body 1. A lower end of the cylinder 10 defines a step 13 protruding inwardly. One end of the levers 5 are engaged with the step 13.

A retainer 14 having a cylindrical configuration is fitted externally around the cylinder 10. The retainer 14 is slidable with respect to the cylinder 10 and can be locked to the cylinder by means of claws 15 formed in an interior surface. A lower end of the retainer 14 defines a collar 16 extending outwardly in a flange configuration, and it may be positioned appropriately, after the male screw 8 of the main body 1 has been coupled to the water supply piping, so that a top surface of the collar 16 is brought into contact with a ceiling bottom surface.

The valve body 2 is designed to block and seal an outlet of the nozzle 7, wherein a collar of the valve body 2 is pressed against an edge of the nozzle 7 with a sealing member 17 interposed therebetween. The valve body 2 is fixedly mounted with a plate-like deflector 3. The deflector 3 is operable such that when nozzle 7 is open, an amount of water discharged from the nozzle 7 can impinge upon the deflector 3 so as the water is dispersed uniformly in all directions within a room.

The deflector 3 has holes drilled therethrough at its peripheral region, through which extend guide pins 18 with collars formed on respective lower ends. The guide pin 18 in its upper end side is fixed to a guide ring 19 which is slidable along an inner surface of the cylinder 10. As the nozzle 7 is open, concurrently with the falling down of the valve body 2, the deflector 3 as well as the guide pins 18 and the guide ring 19 also fall down, and the guide ring 19 is engaged with the step 13 of the cylinder 10, so that the deflector 3 is suspended in a predetermined position.

During non-emergency periods, the valve body 2 is subject to a force that presses the valve body 2 against the nozzle 7, i.e. the valve body 2 is pressed against the nozzle 7 by means of a set-screw 20 from the opposite side of a sealing side of the nozzle 7. The set-screw 20 is threadingly engaged with a female screw 21 formed in a central region of the plate-like saddle 4 which is interposed between the valve body 2 and the levers 5. As the set-screw 20 is threaded into the female screw 21 of the saddle 4 so as to be advanced from the lever 5 side toward the nozzle 7 side, the valve body 2 is pressed against the edge of the nozzle 7, while at the same time, the levers 5 clamped between outer end portion of the saddle 4 and the step 13 of the cylinder 10 are also applied with a load from the saddle 4.

The levers 5 are firmly engaged with the step 13 of the cylinder 10 at one end as stated above, and engaged with the link 6 at the other end. With the load applied to the levers 5 from the saddle 4, the levers 5 are subject to a force acting in a direction which causes the other end of the levers 5 to rotate outward, with the one end of the levers 5 engaged with the step 13 of the cylinder 10 serving as a fulcrum point. However, the actual rotation is prevented by the other end of the levers 5 being engaged with the link 6.

Each lever 5 is bent approximately into an L-shape, with the one end to be engaged with the cylinder 10 being bent in a circular arc configuration and an end surface being formed to be approximately horizontal. The saddle 4 is carried on a top of a bent portion of the circular arc. The lever extends downwardly from the bent portion of the circular arc to the other end, and a V-shaped groove is provided in the other end of the lever 5 for engaging the link 6 therein.

In the lever 5, a bent portion 22 at a corner located in the middle of the L-shape is formed to be approximately vertical so that the respective bent portions 22 of levers 5 contact with each other under the condition where the link 6 is attached to the lower ends of the levers 5. With the bent portions 22 brought into contact with each other, a space 23 is defined in the bent portions 22 so that the set-screw 20 may be inserted from the link 6 side of the lever 5 through the space 23 and threadingly engaged with the female screw 21 in the saddle 4.

A convex and a concave configuration such as a protrusion 22a and an indentation 22b may be formed in the vertical surfaces of the bent portion 22, as shown in FIG. 3(a), so that the pair of levers can be mated with each other by means of the convex and concave engagement. Other configurations in the bent portions in addition to those described above may be used, including a convex and a concave configuration formed as a longitudinal ridge and a longitudinal groove as shown in FIG. 3(b) and a fitting employing a notch 22b as shown in FIG. 3(c).

Further, as an alternative lever configuration, a lever 5a incorporated in a sprinkler head of FIG. 4 is formed in such a way that an end portion of the lever 5a to be engaged with the cylinder 10 is bent in a circular arc and an end surface is approximately horizontal, in a similar manner to the lever 5 as previously described. The lever, however, extends vertically from the bent portion of the circular arc to the other end, where a V-shaped groove is provided for engaging the link 6 therein. In addition, a pair of contact portions 22c extends laterally from both side surfaces of one of the levers 5a toward the other of the levers 5a, where the contact portions 22c of the one of the levers 5a are brought into contact with the other of the levers 5a.

The contact portions 22c may be formed such that respective contact portions 22c of the pair of levers 5a may come in contact with each other in the intermediate portion between the levers as shown in FIG. 4 or the contact portions 22c may be formed only in one of the levers 5a.

The link 6 comprises two sheets of metal plates 24, each having a U-shape, which are placed one on the other in the opposite orientations and connected together with a fusible alloy, wherein once the two metal plates have been connected together, a rectangular aperture is formed in a central region of the link 6. An engaging portion is defined in an edge portion of the aperture for engaging the lever 5 thereon. Further, the aperture is used for the purpose of passage of a fastening tool for the set-screw 20 when threading the set-screw 20 into the saddle 4.

A procedure for assembling a sprinkler head of the present invention will be now described.

Firstly, a pair of levers 5 is placed with their contact regions 22 coupled with each other and engaged with the link 6 at the lower ends thereof. Subsequently, the valve body 2 and the deflector 3 are fixedly attached to each other, and the guide pins 18 are inserted through the holes located in the peripheral region of the deflector 3 and the ends of the guide pins 18, 18 are fixed to the guide ring 19.

The assembled levers 5, 5 along with the associated link 6 are inserted into the cylinder 10 such that the tips of the upper side of the levers 5 are engaged with the step 13 of the cylinder 10. Subsequently, the saddle 4, assemblies of the deflector 3, the valve body 2, the guide ring 19 and others, and the sealing member 17, are inserted sequentially into the cylinder.

Subsequently, the cylinder 10 and the main body 1 are connected together. As in the condition where the protrusions 12 of the cylinder 10 have been fitted from below into the holes 11 in the main body 1, a load is applied to and thus deforms the tips of the protrusions 12 to fix the main body 1 with the cylinder 10. Then, the set-screw 20 is threadingly engaged with the female screw 21 in the saddle 4. In this step, the set-screw 20 is passed through the aperture in the link 6 and the space of the levers 5 to be threadingly engaged with the female screw 21.

Threading the set-screw 20 into the female screw 21 causes the tip of the set-screw 20 to press the valve body 2 against the outlet edge of the nozzle 7. At the same time, the load is also applied to the levers 5 via the saddle 4, and the levers 5 are subject to such a force acting in the direction that would notate the levers 5 outwardly, which in turn places the link 6 under the tensile load.

An operation of the sprinkler head of the present invention will now be described.

The sprinkler head of the present invention is connected to the water supply piping by means of the external thread 8 of the main body 1 and adjusted such that the link 6 assembly located at the lower end of the sprinkler head is situated approximately at the same level as the ceiling surface and that the collar 16 of the retainer 14 is placed in contact with the ceiling bottom surface. In case of fire, a volume of air that has been heated by heat from the fire will rise up and drift along the ceiling bottom surface. The hot air stream drifting along the ceiling bottom surface transfers the heat to the link 6 so as to melt the fusible alloy used for connection of the link 6. This melting of the fusible alloy causes a separation of the two sheets of metal plates 24 forming the link 6 from each other, so that the lever 5 which has been engaged with the metal plates 24, i.e. the ends of the levers 5 which has been engaged with the link 6, can rotate outward.

As the levers 5 rotate, they disengage from the step 13 of the cylinder 10, and the valve body 2, the deflector 3 and the saddle 4 that have been all held in place will fall down. As this occurs, the guide ring 19 coupled with the deflector 3 by means of the guide pins 18 will slidably move down along the inner surface of the cylinder 10 to be engaged with the step 13, leaving the deflector 3 suspended at a predetermined portion. Since the valve body 2 has fallen down, the nozzle 7 is now open to allow an amount of water within the water supply piping system to be discharged.

The amount of water discharged from the nozzle 7 impinges upon the deflector 3 and the valve body 2, and is scattered in all directions and thus dispersed uniformly within the room for extinguishing a fire.

### BRIEF DESCRIPTION OF THE DRAWINGS

FIG. 1 is a sectional view of a sprinkler head of the present invention;

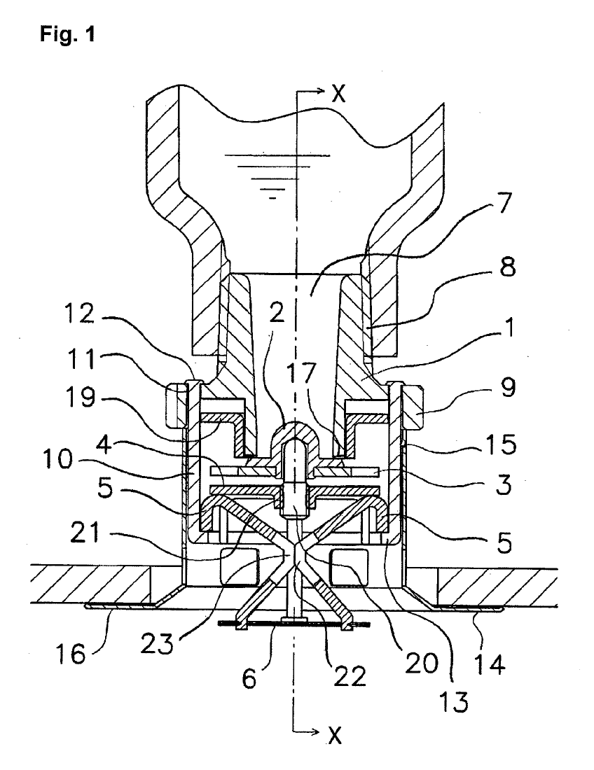

FIG. 2 is a sectional view of the sprinkler head taken along the X-X line of FIG. 1;

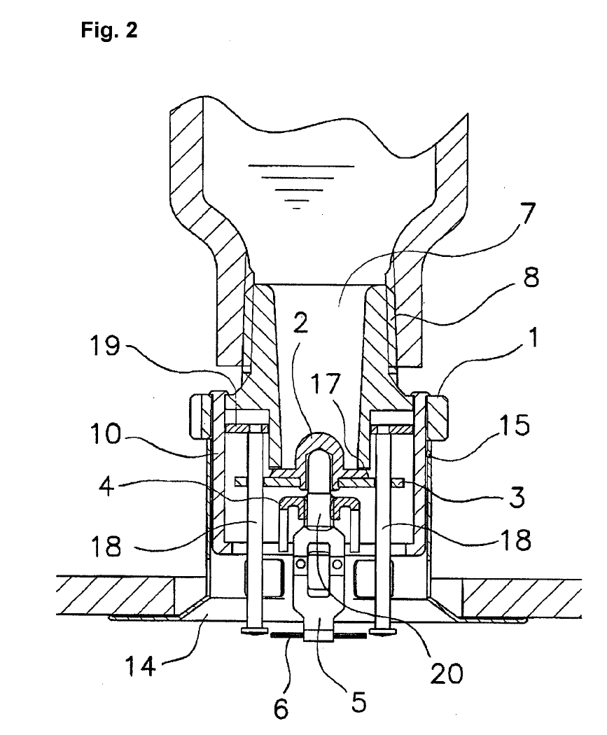

FIGS. 3(a)-3(c) represent alternative embodiments of a lever;

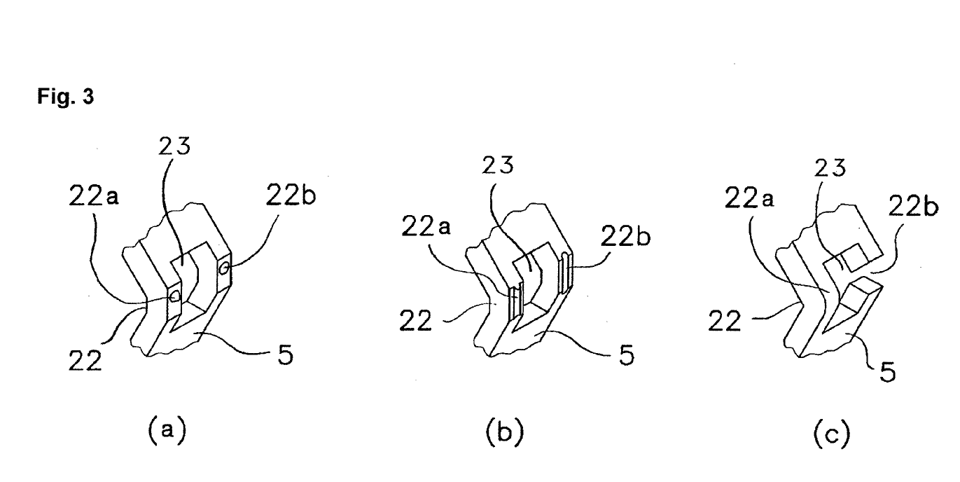

FIG. 4 is a sectional view of a sprinkler head incorporated with a lever according to the alternative embodiment;

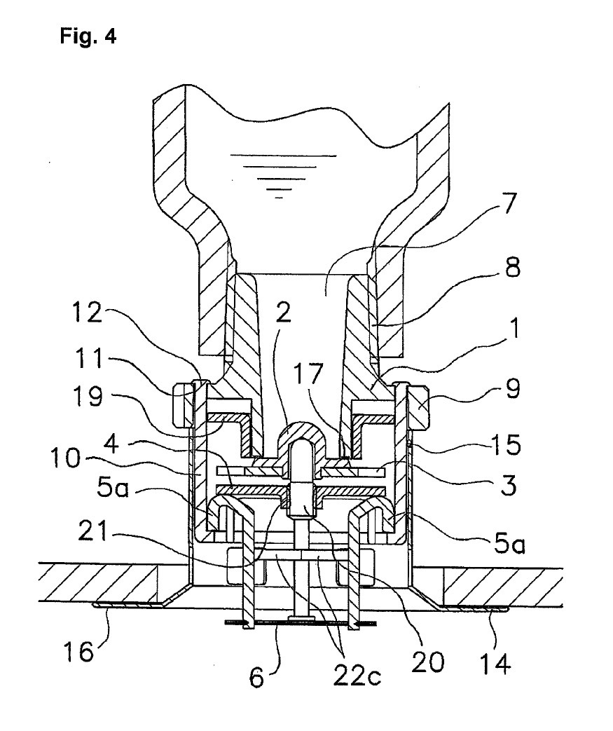

FIG. 5 is an exploded perspective view of a link;

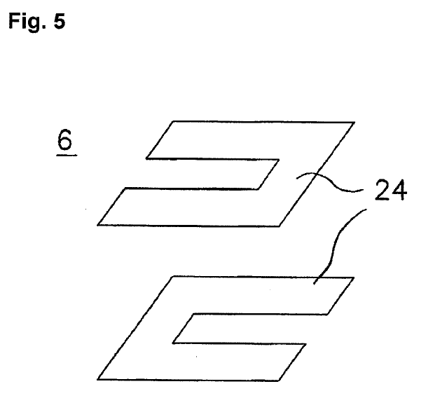

FIG. 6 shows the sprinkler head of FIG. 1 in operation; and

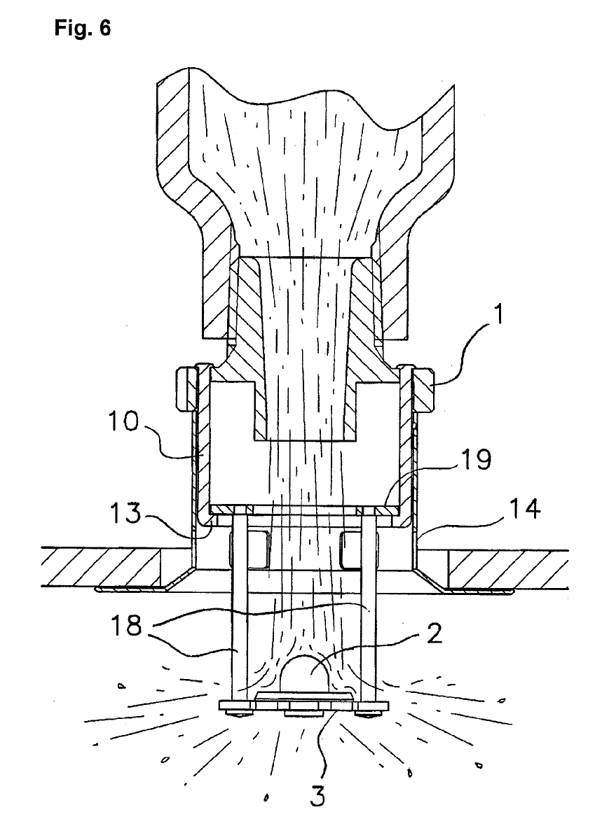

FIG. 7 is a sectional view of a sprinkler head according to the prior art.

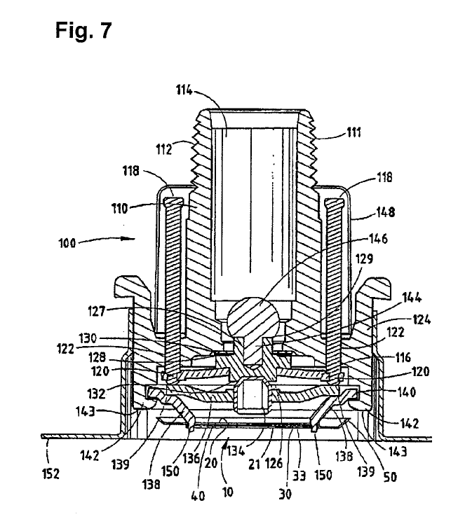

### EXPLANATION OF THE REFERENCE NUMERALS

1 Main body
2 Valve body
3 Deflector
4 Saddle
5 Lever
6 Link
7 Nozzle
10 Cylinder
14 Retainer
17 Sealing member
18 Guide pin
19 Guide ring
20 Set-screw
22 Contact region
23 Space

1. A sprinkler head comprising a main body having a nozzle connected to a water supply piping system, in which an outlet of said nozzle is closed by a valve body, said valve body is pressed against said outlet of the nozzle by a set-screw from the opposite side of said nozzle, and said set-screw is threadingly engaged with a female screw in a saddle interposed between said valve body and a pair of levers whose one end are engaged with a step provided at a lower end of said main body, wherein said levers are fixedly clamped by and between said step and said saddle by threading of said set-screw into the saddle, and the other ends of said levers are engaged with a heat-sensitive decomposition structure comprising two sheets of metal plates connected together with a fusible alloy, said sprinkler head characterized in that said levers are provided with contact regions in their intermediate portions respectively which are capable of being held in contact with each other while said levers are engaged with the heat-sensitive decomposition structure and in that a space is formed in said intermediate portions of said levers along an axis of said female screw in said saddle.

2. A sprinkler head in accordance with claim 1, characterized in that said lever is formed into an L-shape by bending of the intermediate portion thereof.

3. A sprinkler head in accordance with claim 2, characterized in that said space formed in the bent portion of said lever is an aperture.

4. A sprinkler head in accordance with claim 2, characterized in that said space formed in the bent portion of said lever is a notch.

5. A sprinkler head in accordance with claim 1, characterized in that said contact region of said lever comprises a contact portion formed to extend from said intermediate portion of one lever toward the other lever.
